(19) United States
(12) Patent Application Publication
(10) Pub. No.: US 2015/0151259 A1
(43) Pub. Date: Jun. 4, 2015

(54) MIXER FOR MIXING AT LEAST TWO FLOWABLE COMPONENTS

(71) Applicant: SULZER MIXPAC AG, Haag (CH)

(72) Inventor: Josef Ettlin, Eichberg (CH)

(21) Appl. No.: 14/402,797

(22) PCT Filed: Mar. 26, 2013
(86) PCT No.: PCT/EP2013/056379

§ 371 Date: Nov. 21, 2014

(30) Foreign Application Priority Data
May 24, 2012 (EP) 12169331.1

(51) Int. Cl. B01F 5/06; B32B 37/14; B29C 65/02

(52) U.S. Cl. CPC B01F 5/06; B29C 65/02; B32B 37/144; B29L 2031/748

(57) ABSTRACT

The invention relates to a mixer for mixing at least two flowable components and to methods for producing a mixer of this type. The invention is based on a mixer (11) having a tubular mixer housing (18) which extends in the direction of a longitudinal axis (13) as far as a distal mixer end (16) which has an outlet opening (17) for the components. A mixing element (12) for thoroughly mixing the components is arranged within the mixer housing (18). According to the invention, the mixer housing is formed from a plastics sheet which has a thickness of at maximum 0.5 mm. The mixer housing (18) and therefore also the entire mixer (11) can therefore be produced very cost-effectively.

The invention relates to a mixer for mixing at least two flowable components in accordance with the preamble of claim 1 and to methods for manufacturing a mixer for mixing at least two flowable components in accordance with the preamble of claims 14 and 15.

A mixer for mixing at least two flowable components is described in EP 0 885 651 81 B1. The mixer has a tubular mixer housing which extends in the direction of a longitudinal axis up to a distal mixer end which has an outlet opening for the components. A mixing element in the form of a static mixer is arranged within the mixer housing for mixing the components.

The exact design of the mixer housing is not looked at further in EP 0 885 651 81 B1. It is, however, known that mixer housings of such mixers are composed of plastic and are manufactured by means of an injection molding process. The mixer housing then usually has a wall thickness of approximately 0.8 to 2.0 mm. In the manufacture of such mixers, the mixer housing and the mixing element are first manufactured in separate injection molding processes and subsequently the mixing element and the mixer housing are combined.

In view of this, it is the object of the invention to provide a mixer for mixing at least two flowable components and methods for manufacturing such mixers which allow inexpensive mixers. In accordance with the invention, this object is satisfied by a mixer having the features of claim 1 and methods having the features of claims 14 and 15.

In accordance with the invention, the mixer housing is made from a plastic film which has a thickness of a maximum of 0.5 mm. Plastic films can be manufactured in large volumes and very favorably. It is furthermore possible to bring plastic films into a desired size very simply and inexpensively. There are very many suppliers which offer the most varied plastic films in different sizes and shapes. In addition, sophisticated machinery is available, in particular in the packaging industry, by means of which plastic films can be processed fast and inexpensively in high volumes. The mixer housing and thus also the total mixer can thus be manufactured very inexpensively.

A further advantage of the mixer in accordance with the invention is that the waste volume of components remaining in the mixer after the end of mixing and dispensing is very small. The mixer is usually placed onto a receptacle having at least two separate containers, for example onto a two-component cartridge, which contains the components to be mixed. In this respect, it is frequently a question of components which react with one another after the mixing and in so doing harden, for example, so that the mixer can only be used once since the components remaining in the mixer react with one another and thus make the mixer unusable. For mixing and dispensing the components, the latter are pressed out of the cartridge into the mixer. They are mixed there and leave the mixer via the outlet opening. Since the mixed components can only be dispensed via the outlet opening by following components, a waste volume of components always remains in the mixer after the end of mixing and dispensing. Since the plastic film can lie very tight on the mixing element and can also arch into outwardly disposed cut-outs of the mixing element, the volume between the mixer housing and the mixing element in which components can be located can be very small. The above-named waste volume is thus also very small, which allows an effective utilization of the components in the named receptacle. It is, however, also possible that more than two components are mixed using the mixer.

The mixer is in particular designed as a static mixer. In contrast to a dynamic mixer which has a rotating mixing element for mixing the components, a static mixer has a fixed-position mixing element which allows an efficient mixing of the components due to its special shape.

In an embodiment of the invention, the plastic film is designed as a plastic film which shrinks on heating. The plastic film then in particular has a thickness of approximately 0.03 to 0.07 mm.

The plastic film can in particular be designed as a polyester film, in particular from polyethylene terephthalate (PET). It is also possible that the plastic film is made from polyvinyl chloride (PVC), polystyrene (PS), from so-called bioplastic such as polylactic acid (PLA) or another suitable plastic. The plastic film can also be made from a multilayer film having a plurality of layers.

On a use of such a plastic film, the mixing housing can be shrunk onto the mixing element simply and inexpensively under the effect of heat for manufacturing the mixer. Such processes are frequently used for labeling, for example of beverage bottles of glass or plastic, and are therefore tried and tested many times. These processes are known as so-called sleeve processes.

In an embodiment of the invention, the plastic film is made as a plastic film stretched only in one direction. Plastic films can be stretched, that is extended, during manufacture to improve their properties. The plastic film can in this respect be stretched either only in one direction or also in two directions standing perpendicular to one another. In particular a plastic film stretched only in one direction is advantageous for the use for shrinking onto the mixing element. The plastic film is then arranged so that the direction of stretching is oriented to the peripheral direction, that is perpendicular to the longitudinal axis of the mixer. On the shrinking onto the mixing element, the plastic film mainly shrinks in the direction of stretching and thus in the peripheral direction so that it can lie tight on the mixing element. An excessive shrinking in the longitudinal direction is not necessary and also not desired since otherwise there is a risk that the plastic film shrinks so much in the longitudinal direction and the mixing housing then no longer extends over the total length of the mixer. On a use of such a plastic film, a reliable and reproducible manufacturing process can be achieved. Films can, however, also be used which are stretched in two directions, that is so-called biaxially stretched plastic films.

It is of particular advantage for the use of such a sleeve process if the mixer housing is manufactured starting from a plastic hose. For manufacturing the mixer, the mixing element is then arranged within the plastic hose and the plastic hose is subsequently shrunk onto the mixing element arranged within the plastic hose under the effect of heat. The manufacture is thus particularly effective and inexpensive.

In an embodiment of the invention, the mixer has a connector region which is configured in one piece with the mixing element and by means of which the mixer can be connected to a container containing the components to be mixed, for example to a two-component cartridge. The connector region is arranged at least partly within the mixer housing. The connector region in particular has a larger diameter with respect to the mixing element. A particularly firm and secure connection between the plastic film and the combination of connector region and mixer housing can be achieved by the shrinking of the plastic film onto at least a portion of the connector region. The connection is in particular strained in the longitudinal direction of the mixer on the dispensing of the components. To improve the connection, peripheral ribs or grooves can be arranged at an outer periphery of the connector region.

The combination of mixing element and connector region is in particular manufactured from plastic by means of an injection molding process.

In an embodiment of the invention, the plastic film is designed as a weldable plastic film. The plastic film can in this respect be composed only of a weldable plastic such as polyethylene (PE) or polypropylene (PP). The plastic film is, however, in particular designed as a multilayer film, with at least the outer layers being weldable. The plastic film has at least one inner layer between the two outer layers, with the inner layer being designed as a so-called barrier layer. The plastic film can also have more than one inner layer, for example three inner layers.

The weldable outer layers are in particular made of polyethylene (PE). The inner layer or the inner layers can be composed, for example, of polyamides, polyesters, glass, metal or another suitable material.

In an embodiment of the invention, the mixer housing has a first weld seam which is oriented along the mixer axis and by means of which a first end of the plastic film and a second end of the plastic film are welded to one another. The mixer housing is manufactured from the plastic film in a simple and thus inexpensive manner due to this named first weld seam.

To achieve a particularly secure fixing of the mixer housing at the mixing element, the named first end of the plastic film is welded to the mixing element so that the mixer housing has a second weld seam between the first end of the plastic film and the mixing element. For this purpose, a contact surface between the first end of the plastic film and the mixing element should be as planar and as large as possible. It is also possible that the plastic film is welded to the mixing element over a wide area. It is in particular to be understood by this that the plastic film is welded to all outwardly disposed areas of the mixing element.

On the manufacture of the mixer, the first end of the plastic film is first welded to the mixing element, then the plastic film is wound around the mixing element and subsequently the second end of the plastic film is likewise welded to the first end of the plastic film along the longitudinal axis.

In an embodiment of the invention, the outlet opening is designed as a connector for an applicator which can be plugged on. The applicator can, for example, be designed as a flexible thin tube by means of which the mixed components can be applied particularly precisely to the desired points. Such applicators are frequently used in the dental field so that such a connector is also designated as a so-called “intra oral tip” connector (IOT connector). The mixer is thus particularly versatile in use.

The named connector for an applicator is in particular configured in one piece with the mixing element. No additional connection is thus necessary between the connector and the mixing element or the mixer housing, which enables a particularly simple design of the mixer.

The combination of mixing element and connector for an applicator is in particular established from plastic by means of an injection molding process.

The named connector for an applicator can in particular also be designed as a separate component, with it then being arranged at least partly within the mixer housing and thus being held by the mixer housing. This design can be advantageous when the manufacture of a mixer element with an integrated connector for an applicator is too complicated and is too expensive in manufacture. The connector can be fixed to the mixer by the at least partial arrangement of the connector within the mixer housing. The connector and the mixing element can have peripheral ribs or grooves for a firm fixing.

The named object is also satisfied by a method of manufacturing a mixer for mixing at least two flowable components, wherein the mixer has a tubular mixer housing which extends in the direction of a longitudinal axis up to a distal mixer end which has an outlet opening for the components. At least one mixing element is arranged in the mixer housing for mixing the components. In accordance with the invention, for the manufacture of the mixer housing, the mixing element is arranged in a hose made of a plastic film which is shrunk so far in the radial direction under the effect of heat until the plastic film contacts the mixing element.

The named object is also satisfied by a method of manufacturing a mixer for mixing at least two flowable components, wherein the mixer has a tubular mixer housing which extends in the direction of a longitudinal axis up to a distal mixer end which has an outlet opening for the components. At least one mixing element is arranged in the mixer housing for mixing the components. In accordance with the invention, a first end of a plastic film is welded to the mixing element along the longitudinal axis. Subsequently, the plastic film is wound around the mixing element and then a second end of the plastic film is likewise welded to the first end of the plastic film along the longitudinal axis.

Further advantages, features and details of the invention result with reference to the following description of embodiments and with reference to drawings in which elements which are the same or have the same function are provided with identical reference numerals.

There are shown:

FIG. 1 a mixer for mixing at least two flowable components having a mixer housing made from a shrunk-on plastic film;

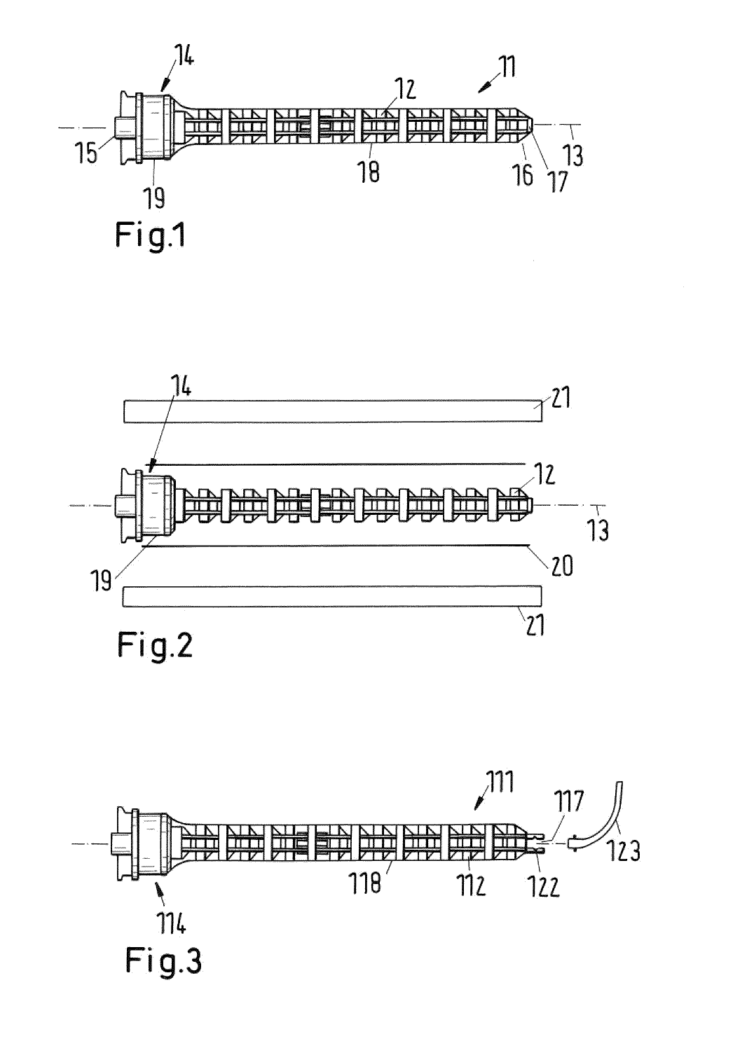

FIG. 2 the mixer of FIG. 1 before the shrinking on of the plastic film;

FIG. 3 a mixer with a connector for an applicator;

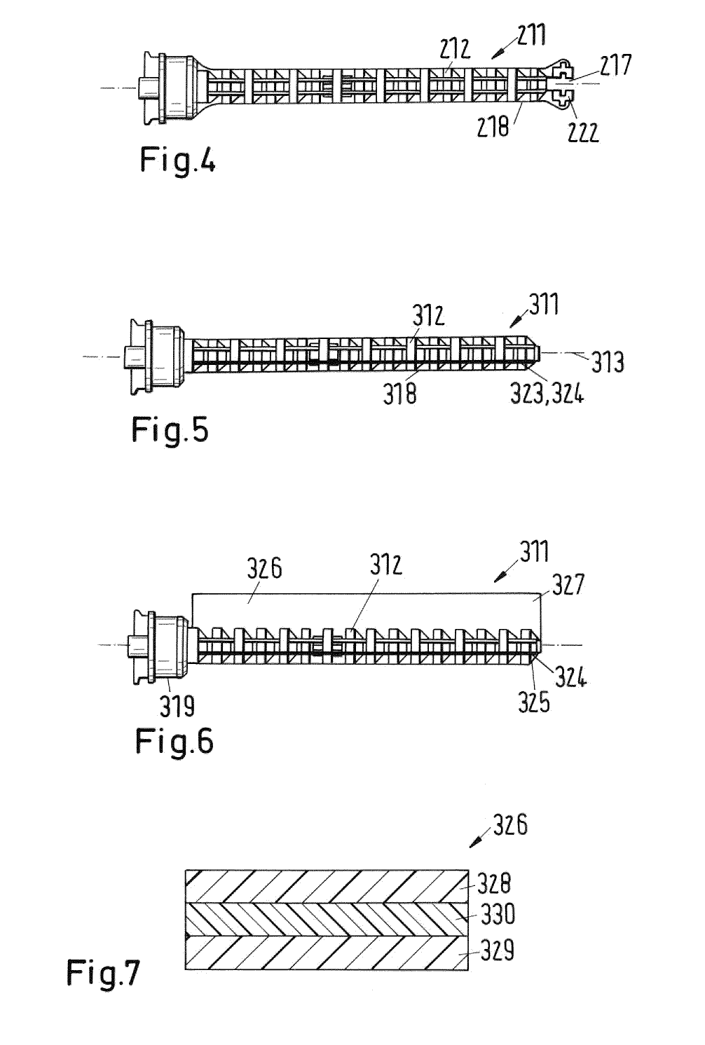

FIG. 4 a mixer with a connector for an applicator in a second embodiment;

FIG. 5 a mixer for mixing at least two flowable components having a mixer housing made from a shrunk-on plastic film;

FIG. 6 the mixer of FIG. 5 before the complete welding of the plastic film; and

FIG. 7 a sectional representation of a multilayer plastic film which can be used for a mixer housing.

In accordance with FIG. 1, a mixer 11 for mixing at least two flowable components has a static mixing element 12 which has a mainly cylindrical outer contour. The mixing element 12 extends along a longitudinal axis 13 of the mixer 11. The mixing element 12 is made in one piece with a connector region 14 by means of which the mixer 11 can be connected to a two-component cartridge, not shown. The connector region 14 has two separate mixer inlets via which the components to be mixed can be supplied to the mixer 11 from the two-component cartridge. However, only one mixer inlet 15 is shown in FIG. 1. The second mixer inlet is arranged behind the mixer inlet 15 in the view of FIG. 1. The mixing element 12 and the connector region 14 are made from plastic by means of an injection molding process. The mixing element 12 has a special geometry which allows a good mixing of the components. The precise geometry of the mixing element 12 is not of any further interest here.

The mixer 11 extends from the connector region 14 along the longitudinal axis 13 up to a distal mixer end 16 which has an outlet opening 17 for the mixed components.

The mixer 11 additionally has a mixer housing 18 which extends along the longitudinal axis 13. The mixing element 12 and a part region 19 of the connector region 14 adjacent to the mixing element 12 are arranged within the mixer housing 18. The mixer housing 18 is made from a plastic film which has a thickness between 0.03 and 0.2 mm. The plastic film is made, for example, as a film of polyethylene terephthalate only stretched in one direction. The plastic thus shrinks on heating and indeed in particular in the direction in which it was stretched on the manufacture.

In FIG. 2, the mixer 11 is shown with a mixer housing not yet shrunk on. To manufacture the mixer 11, the mixing element 12 and the named part region 19 of the connector region 14 are arranged in a plastic hose 20 of plastic film which later forms the mixer housing 18. The plastic film from which the plastic hose 20 is made is stretched in the peripheral direction, that is perpendicular to the longitudinal axis 13. Heating elements 21 are arranged around the plastic hose 20 which heat the plastic hose 20 so that it is shrunk onto the mixing element 12 and the named part region 19 of the connector region 4. The plastic hose 20 is therefore shrunk so far in the radial direction by the heat effect until the plastic film contacts the mixing element. Such a process is known as a so-called sleeve process.

The mixer can also additionally have a connector for an applicator which can be plugged on. Such a mixer 111 is shown in FIG. 3. The mixer 111 has a very similar structure to the mixer 11 of FIG. 1 so that mainly the differences of the two mixers will be looked at.

In accordance with FIG. 3, the connector 122 for an applicator 123 is designed in one piece with a mixing element 112. The connector 122 then forms an outlet opening 117 of the mixer 111. The unit of connector region 114, mixing element 112 and connector 122 is likewise manufactured from plastic by means of an injection molding process. The mixer housing 118 in this embodiment ends in the region of the connector 122.

The applicator 123 is designed as a flexible thin tube in this case. It can, however, also have a different shape. It is designed so that it can be placed onto the connector 122 and snapped into place.

A mixer 211 having a connector for an applicator is shown in a second embodiment in FIG. 4. The mixing element 212 and the connector 222 for an applicator not shown in FIG. 4 is made of two separate components in this embodiment. The mixing element 218 also surrounds a part of the connector 222 and thus fixes the connector 222 to the mixer 211. The connector 222 then forms an outlet opening 217 of the mixer 211.

In addition to the described method of manufacturing the mixer housing by shrinking, the mixer housing can also be manufactured from a plastic film in a different manner. Such a mixer is shown in FIG. 5.

The mixer 311 has a very similar structure to the mixer 11 of FIG. 1 so that mainly the differences of the two mixers will be looked at. The mixer 311 has a mixer housing 318 which is composed of a multilayer plastic film and is manufactured by welding. In FIG. 6, the mixer 311 is shown with a not yet fully completed mixer housing 318. The structure of the plastic film will be looked at in more detail further below in connection with FIG. 7.

The mixer housing 318 only extends along the mixing element 312 in the mixer 311. The mixer housing 318 has two weld seams 323, 324 which are oriented along the longitudinal axis 313. A first end 325 of the plastic film 326 and s second end 327 of the plastic film 326 are connected to one another by the first weld seam 323. The named first end 325 of the plastic film 326 is welded to the mixing element 312 by the second weld seam 324, with the second weld seam 324 being applied before the first weld seam 323. The two weld seams 323, 324 lie above one another in this embodiment. They can, however, also be arranged at different points at the periphery of the mixing element.

In FIG. 6, the mixer 311 is shown after the application of the second weld seam 324 and before the application of the first weld seam 323. After the welding of the first end 325 of the plastic film 326 to the mixing element 312 along the longitudinal axis 313, the plastic film 326 is wound around the mixing element 312 and finally the second end 327 of the plastic film 326 is likewise welded to the first end 325 of the plastic film 326 along the longitudinal axis 313. The plastic film 326 in this respect has a thickness of, for example, approximately 0.1 mm.

If a connector region for the connection to a two-component cartridge has openings which have to be covered, a second plastic film can be arranged around the connector region. This second plastic film can likewise be fixed by welding.

The mixer with the welded mixer housing can likewise have a connector for an applicator. This connector can likewise be made in one piece with the mixing element or as a separate component.

The structure of the weldable plastic film 326 is shown in FIG. 7. The plastic film 326 has two outwardly disposed layers., that is two outer layers 328, 329, and an inner layer 330 arranged between the two outer layers 328, 329. The outer layers 328, 329 are composed of polyethylene (PE), that is a weldable plastic. The inner layer 330, which acts as a so-called barrier layer, is composed of polyamide (PA). The layers are inseparably connected to one another on the manufacture of the plastic film.

The plastic film can also have more than one inner layer. The layers can also be composed of other suitable materials.

1. A mixer for mixing at least two flowable components comprising
a tubular mixer housing which extends in the direction of a longitudinal axis up to a distal mixer end which has an outlet opening for the components; and
at least one mixing element arranged in the mixer housing for mixing the components,
wherein
the mixer housing is made from a plastic film which has a thickness of a maximum of 0.5 mm.

2. The mixer in accordance with claim 1, in which
the plastic film is designed as a plastic film which shrinks on heating.

3. The mixer in accordance with claim 2, in which
the plastic film is designed as a plastic film only stretched in one direction.

4. The mixer in accordance with claim 2, in which
the mixer housing is manufactured starting from a plastic hose that is shrunk onto the mixing element arranged within the plastic hose under the effect of heat.

5. The mixer in accordance with claim 2, in which
the plastic film is designed as a polyester film.

6. The mixer in accordance with claim 1, further comprising
a connector region that is made in one piece with the mixing element and that is arranged at least partly within the mixer housing.

7. The mixer in accordance with claim 1, in which
the plastic film is designed as a weldable plastic film.

8. The mixer in accordance with claim 7, in which
the plastic film is designed as a multilayer film, with at least the outer layers being weldable.

9. The mixer in accordance with claim 7, in which
the mixer housing has a first weld seam oriented along the longitudinal axis by means of which a first end of the plastic film and a second end of the plastic film are welded to one another.

10 The mixer in accordance with claim 9, in which
the mixer housing has a second weld seam that is oriented along the longitudinal axis and by means of which the first end of the plastic film and the mixing element are welded to one another.

11. The mixer in accordance with claim 1, in which
the outlet opening is designed as a connector for an applicator that can be plugged on.

12. The mixer in accordance with claim 11, in which
the connector is made in one piece with the mixing element.

13. The mixer in accordance with claim 11, in which
the connector is designed as a separate component and is arranged at least partly within the mixer housing.

14. A method of manufacturing a mixer for mixing at least two flowable components having
a tubular mixer housing which extends in the direction of a longitudinal axis up to a distal mixer end which has an outlet opening for the components; and
at least one mixing element arranged in the mixer housing for mixing the components,
that the method comprising the steps of
arranging
the mixing element for the manufacturing of the mixer housing in a hose of a plastic film,
shrinking the plastic film so far in the radial direction under the effect of heat until the plastic film contacts the mixing element.

15. A method of manufacturing a mixer for mixing at least two flowable components having
a tubular mixer housing which extends in the direction of a longitudinal axis up to a distal mixer end which has an outlet opening for the components; and
at least one mixing element arranged in the mixer housing for mixing the components,
wherein,
for manufacturing the mixer housing, the method comprises the steps of:
welding a first end of a plastic film to the mixing element along the longitudinal axis;
winding the plastic film around the mixing element; and
likewise welding a second end of the plastic film to the first end of the plastic film along the longitudinal axis.
